(19) United States
(12) Patent Application Publication
(10) Pub. No.: US 2008/0160278 A1
(43) Pub. Date: Jul. 3, 2008

(54) Fade resistant colored sheath/core bicomponent fiber

(76) Inventors: Paul P. Cheng, Old Hickory, TN (US); Robert Howe Peterson, Hendersonville, TN (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/647,095

(22) Filed: Dec. 28, 2006

(51) Int. Cl. A01K 1/015; D02G 3/00; D04H 3/16

(52) U.S. Cl. 428/221; 428/364; 442/301

(57) ABSTRACT

A fade resistant, colored sheath/core bicomponent fiber can be made from a core formed of a melt dye-containing, dye soluble core polymer and a sheath formed of a dye-free, dye insoluble sheath polymer.

### BACKGROUND OF THE INVENTION

1. Field of the Invention

The present invention relates to fade resistant, colored bicomponent fiber.

2. Description of the Related Art

A colored fiber is useful in a wide variety of products including garments, outdoor fabrics, medical drapes, etc. A fiber can be colored by incorporating a dye on the surface or in the body of the fiber. However, after exposure to ultraviolet (UV) radiation, wear, abrasion, bleaching or washing, the color of the fiber can fade due to damage or loss of the dye.

U.S. Pat. No. 5,888,651 discloses bicomponent fibers that are colored in one domain and color-free in the other domain. The colorant is a pigment, not a dye.

U.S. Pat. No. 6,531,218 discloses sheath/core bicomponent fibers that are colored in a dye bath, wherein the dye migrates through the sheath and colors the core.

What is needed is a colored fiber that resists fading.

### SUMMARY OF THE INVENTION

This invention is directed to a fade resistant, colored sheath/core bicomponent fiber made from a core formed of a melt dye-containing, dye soluble core polymer and a sheath formed of a dye-free, dye insoluble sheath polymer.

### DETAILED DESCRIPTION OF THE INVENTION

The present invention provides fade resistant colored sheath/core bicomponent fibers wherein the core is formed from a dye-containing polymer and the sheath is formed from a substantially dye-free polymer. More specifically, the dye is melt soluble in the core polymer and the dye is not substantially melt soluble in the sheath polymer. The dye-free sheath preferably completely encapsulates the dye-containing core. The fiber is fade resistant due to the sheath which protects the dye in the core by preventing loss of the dye from the core and diffusing the ultraviolet radiation or bleaching detergent to reduce the dye damaging effect of the radiation.

The bicomponent fiber of the present invention has a sheath/core cross section. The sheath completely encapsulates the core to provide protection for the core. The core occupies between about 10 to about 90 percent of the cross sectional area of the fiber and the sheath occupies between about 10 to about 90 percent of the cross sectional area of the fiber. The core can be either concentric or eccentric. The fiber can have a generally round cross sectional shape.

Dyes suitable for the present invention are dyes soluble in the core polymer while much less soluble or insoluble in the sheath polymer. For a dye to be soluble, the dye molecule has to be fully soluble to the molecular level to form a single phase with the polymer. Many organic dyes have polar molecular groups that are more soluble in polymers with polar characteristics and less soluble or insoluble in polymers with non-polar characteristics. Organic polar dyes come in many colors including bright, fluorescent colors. For example fluorescence dye, oxazine 9, also known as cresyl violet containing various polar functional groups and it is soluble in ethanol. Typical fluorescence dyes are Rhodamine B, Coumarin 9, and sodium salicilate. Organic polar dyes are soluble in polymers with polar characteristics such as polyesters including poly(ethylene terephthalate), polyamides including nylon 6 and nylon 6,6, and copolymers and blends thereof. Organic polar dyes are less soluble or insoluble in polymers with non-polar characteristics such as polyolefins including polyethylene and polypropylene, and copolymers and blends thereof. Particularly useful combinations of polymers for bicomponent fibers containing organic polar dyes are polyethylene/poly(ethylene terephthalate), polyethylene/nylon 6 and polyethylene/nylon 6,6 sheath/core fibers. In one embodiment, the amount of the core poly(ethylene terephthalate) can be adjusted to be 20% to 80 wt % of the fiber. The presence of polyethylene as the sheath aids in the point bonding operation being conducted at 130 to 145° C. depending on the spinning rate.

The bicomponent fibers of the present invention are made by melt mixing the dye into the core polymer. The dye can be mixed into the polymer in a highly concentrated form or master batch of about 5% to about 30% by weight to be melt mixed with additional dye-free polymer prior to spinning or can be mixed into the polymer in a ready to spin concentration of about 0.1% to about 10% by weight. The dye-containing, dye soluble core polymer and the dye-free, dye insoluble sheath polymer can be spun by conventional bicomponent fiber melt spinning processes. Conventional melt spinning processes produce fibers that can be collected into yarns and used as continuous fibers or chopped into staple fibers. Other examples of these types of melt spinning processes include spunbond and meltblowing processes. These processes spin fibers that are collected as nonwoven webs. These webs can be further processed or treated, for example bonded, coated etc., or combined with other webs, for example to make a spunbond/meltblown/spunbond composite nonwoven web. These fibers and webs can be used to make garments, outdoor fabrics, medical drapes, etc.

### Test Methods

In the description above and in the examples that follow, the following test methods were employed to determine various reported characteristics and properties.

Ultraviolet Radiation Stabilization is a measure of loss in color intensity after exposure to ultraviolet radiation. A Xenon arc UV accelerate Weatherometer was used to perform the test. The test was conducted according to ASTM G-26(A), which is hereby incorporated by reference and is reported as x, y, and Y values. It is noted that ASTM G26 has been withdrawn and replaced with G155 nevertheless the test was conducted in accordance with the former. The x and y values are chromaticity coordinates which are used to determine the accuracy of the color being represented. Y is a measure of the fluorescent laser light intensity. The test used a 340 nm irradiance filter, the light cycle setting was 0.35 W/m² at 63° C. and 50% relative humidity. Cycle duration was 1200 minutes.

Basis Weight is a measure of the mass per unit area of a fabric or sheet and was determined by ASTM D-3776, which is hereby incorporated by reference, and is reported in g/m².

### EXAMPLE

Hereinafter an embodiment of the present invention will be described in more detail in the following example.

A fade resistant, colored sheath/core bicomponent fiber was made from a core formed of a melt dye-containing, dye soluble core polymer and a sheath formed of a dye-free, dye insoluble sheath polymer. An organic polar dye Solvent Yellow 98 from Clariant was melt mixed at 270° C. with co-poly(ethylene terephthalate) Crystar 4446 from DuPont to make a concentrated dye/polymer master batch of 40% dye by weight. The concentrated master batch was further melt mixed with additional poly(ethylene terephthalate) Crystar 4415 to yield a dye concentration of 0.05 to 5%. This dyed poly(ethylene terephthalate) was spun through a concentric core component of a bicomponent fiber spunbond apparatus. The sheath polymer was polyethylene Equistar XH4620 from Equistar. The polyethylene was spun through the sheath component of the bicomponent fiber spunbond apparatus. The melt temperature of the poly(ethylene terephthalate) was maintained at about 290° C. and the temperature of the polyethylene was maintained at about 270° C. A spunbond web was collected with a basis weight of 85 g/m². The web was point bonded at 140° C. and 300 PSI.

The webs were tested before after exposure to a Xenon arc accelerate Weatherometer in a one ply or two ply sample. The results are listed in the Table.

TABLE

| Example | Plys | Condition | x | y | z |
|---|---|---|---|---|---|
| 1 | 1 | Before | 0.3822 | 0.5035 | 71.382 |
| 2 | 1 | After | 0.3827 | 0.4985 | 76.284 |
| 3 | 2 | Before | 0.3915 | 0.5095 | 93.762 |
| 4 | 2 | After | 0.3925 | 0.5064 | 93.905 |

The x, y, and Y values indicate the change of the color as well as the capability of the dye to deliver sufficient intensity of fluorescent light.

The data from the Table shows no deterioration in color intensity after exposure to ultraviolet radiation. This indicates that the dye did not decompose.

Webs as above were washed in hot water and soap in a standard washing cycle 10 times and also tested as above. The resultant x, y and Y coordinates were indicative the polyethylene sheath provided protection for the dye that was embedded in the core polymer.

What is claimed is:

1. A fade resistant, colored sheath/core bicomponent fiber, comprising a core formed of a melt dye-containing, dye soluble core polymer and a sheath formed of a substantially dye-free, substantially dye insoluble sheath polymer.

2. The fiber of claim 1, wherein the core is concentric or eccentric.

3. The fiber of claim 1, wherein the sheath/core fiber has a generally round cross sectional shape.

4. The fiber of claim 1, wherein the core occupies between about 10 to about 90 percent of the cross sectional area of the fiber and the sheath occupies between about 10 to about 90 percent of the cross sectional area of the fiber.

5. The fiber of claim 1, wherein the core polymer is selected from the group consisting of polyester, polyamide and copolymers and blends thereof.

6. The fiber of claim 1, wherein the sheath polymer is selected from the group consisting of polyolefin and copolymers and blends thereof.

7. The fiber of claim 1, wherein the core polymer contains between about 0.1 to about 10 percent by weight of dye.

8. The fiber of claim 1, wherein the dye is selected from organic dyes.

9. The fiber of claim 8, wherein the dye is fluorescent.

10. The fiber of claim 1, wherein the core polymer is poly(ethylene terephthalate), the sheath polymer is polyethylene and the dye is fluorescent.

11. The fiber of claim 1, wherein the fiber is spun from a spunbond process.

12. The fiber of claim 1, wherein the fiber is spun from a meltblown process.

13. A web, comprising the fibers made according to claim 1.

14. A spunbond web, comprising the fibers made according to claim 11.

15. A meltblown web, comprising the fibers made according to claim 12.

16. A spunbond/meltblown/spunbond composite nonwoven comprising a meltblown web located between two spunbond webs, wherein at least one of the spunbond webs is made according to claim 11.

17. The composite nonwoven of claim 16, wherein the meltblown web is made according to claim 12.

18. A garment comprising the webs or composite nonwovens of any one of claims 13 to 17.
